(19) United States
(12) Patent Application Publication
(10) Pub. No.: US 2026/0304378 A1
(43) Pub. Date: Oct. 1, 2026

(54) METHODS, ARCHITECTURES, APPARATUSES AND SYSTEMS FOR EVALUATING SENSING AVAILABILITY OF SENSING ENTITIES

(71) Applicant: InterDigital Patent Holdings, Inc., Wilmington, DE (US)

(72) Inventors: Jung Je Son, Warrington, PA (US); Magurawalage Chathura Madhusanka Sarathchandra, London (GB); Zhibi Wang, Woodridge, IL (US); Catalina Mladin, Hatboro, PA (US); Muhammad Awais Jadoon, London (GB); Filipe Conceicao, London (GB)

(21) Appl. No.: 19/092,895

(22) Filed: Mar. 27, 2025

(51) Int. Cl. H04W 64/00; H04W 8/22

(52) U.S. Cl. CPC H04W 64/006; H04W 8/22

(57) ABSTRACT

Procedures, methods, architectures, apparatuses, systems, devices, and computer program products are provided for integrated sensing and communications. Wireless transmit/receive unit (WTRU) methods and systems include receiving, from a wireless network, configuration information for performing a sensing availability evaluation. The methods and systems further include performing the sensing availability evaluation to determine sensing availability information and transmitting the sensing availability information to the wireless network. The methods and systems additionally include performing a sensing operation based on sensing configuration information received from the wireless network.

### TECHNICAL FIELD

The present disclosure is generally directed to the fields of communications, software and encoding/decoding, including, for example, to methods, architectures, apparatuses, systems related to integrated sensing and communication (e.g., detecting a target object based on configuration of at least one of a wireless transmit/receive unit or a wireless network).

### BACKGROUND

Devices (e.g., wireless transmit/receive units) that are communicatively coupled to a wireless network may be configured by the wireless network to perform sensing operations. During this process, one or more devices may become temporarily unavailable for a particular sensing operation.

### SUMMARY

A wireless transmit/receive unit (WTRU) may be configured for integrated sensing and communication. For example, a WTRU (e.g., a sensing entity) may perform sensing operations based on receiving reference signals from and optionally reporting measurements to another sensing entity (e.g., a gNode-B (gNB)). However, a number of internal and/or external conditions of the WTRU may result in the WTRU becoming temporarily unavailable or not suitable for performing certain sensing operations. For example, the WTRU may enter a geographical area where sensing is not permitted (e.g., by one or more regulations) and may not be available for sensing operations. Accordingly, systems and methods are desired for evaluating sensing availability of a WTRU (e.g., and/or other sensing entities) for performing sensing operations.

In accordance with certain embodiments of this disclosure, the WTRU receives configuration information for performing a sensing availability evaluation and performs the sensing availability evaluation to determine sensing availability information. The WTRU may transmit the sensing availability information to the wireless network, which may configure WTRUs for sensing based on the sensing availability information. Based on the systems and methods of this disclosure, sensing operations performed by WTRUs may be made more robust to changes in WTRU availability, the wireless network may more efficiently and reliably allocate sensing resources for sensing operations, and the need to perform discovery of sensing entities prior to each sensing operation (e.g., of a sensing service) may be reduced.

In accordance with certain embodiments of the present disclosure, methods and systems are provided for operating a WTRU. A method includes receiving, from a wireless network, configuration information for performing a sensing availability evaluation. The method also includes performing the sensing availability evaluation to determine sensing availability information. The method additionally includes transmitting, to the wireless network, the sensing availability information. The method further includes receiving, from the wireless network, sensing configuration information for performing a sensing operation, wherein the sensing configuration information is determined based on the sensing availability information. In some embodiments, the method also includes performing the sensing operation based on the sensing configuration information.

In some embodiments, the WTRU is a sensing entity associated with a sensing group and performing the sensing availability evaluation includes receiving, from another sensing entity associated with the sensing group, one or more sensing reference signals associated with the sensing availability evaluation and performing one or more measurements of the one or more sensing reference signals. In some embodiments, the sensing availability information includes at least one of: internal information (e.g., of the WTRU), external information (e.g., to the WTRU), the one or more performed measurements, combinations of the same, or the like. In some embodiments, the WTRU performs the sensing availability evaluation by monitoring an environment of the WTRU (e.g., to generate a sensing availability evaluation report). In some embodiments, the sensing availability information is transmitted to the wireless network periodically based on the configuration information. In some embodiments, the transmitting the sensing availability information is based on identifying an event trigger indicated by the configuration information. In some embodiments, the WTRU is assigned to a sensing group for a sensing service based on the sensing availability information. In some embodiments, the received configuration information is associated with a sensing group selected, based on the sensing availability information, from a plurality of candidate sensing groups for performing the sensing operation.

In accordance with certain embodiments of the present disclosure, methods and systems are provided for operating a wireless network. A method includes receiving, at a sensing network function (e.g., of the wireless network), a request for a sensing service. The method additionally includes selecting a plurality of sensing entities for the sensing service. The method further includes transmitting, to the plurality of sensing entities, configuration information for performing a sensing availability evaluation. The method also includes receiving, from the plurality of sensing entities, sensing availability information. The method additionally includes selecting one or more sensing entities of the plurality of sensing entities for a sensing operation based on the sensing availability information. The method even further includes transmitting, to the one or more sensing entities, sensing configuration information for performing the sensing operation.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a reference model of an example wireless network with which a WTRU communicates, in accordance with certain embodiments;

FIG. 3 is a diagram depicting an example of a pedestrian and/or animal intrusion detection, in accordance with certain embodiments;

FIG. 4 is a diagram depicting an example of intruder detection in surroundings of a smart home, in accordance with certain embodiments;

FIG. 5 is a flowchart of an illustrative method for wireless network-coordinated sensing availability evaluation of sensing entities, in accordance with certain embodiments;

FIG. 6 is a flowchart of an illustrative method for monitoring sensing availability information of sensing entities, in accordance with certain embodiments;

FIG. 7 is a flowchart of an illustrative method performed by a WTRU for evaluating sensing availability of sensing entities, in accordance with certain embodiments; and

FIG. 8 is a flowchart of an illustrative method performed by a wireless network for evaluating sensing availability of sensing entities, in accordance with certain embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

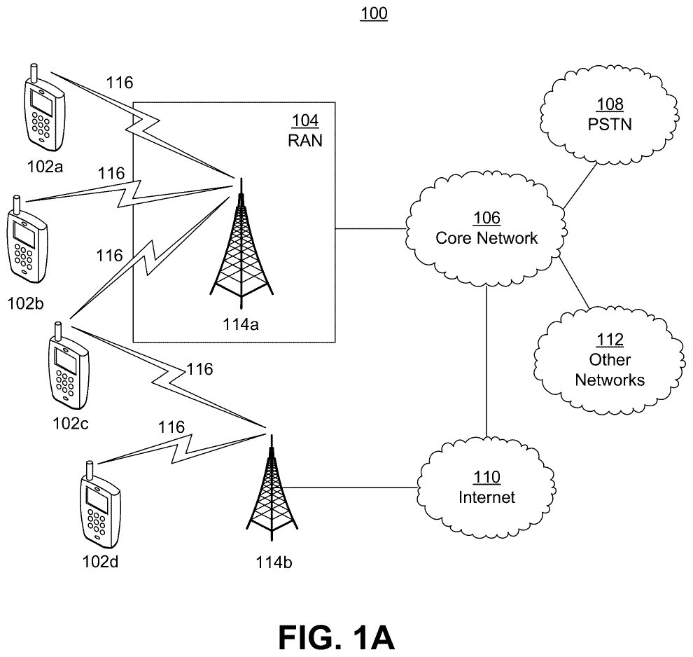

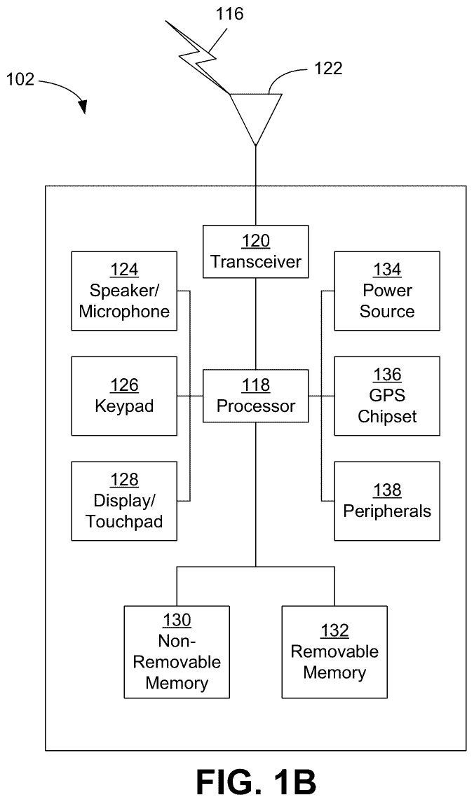

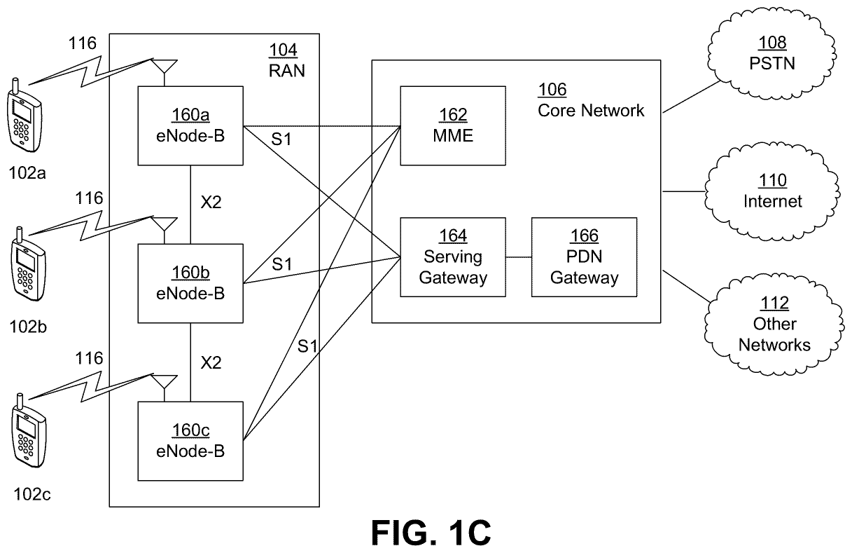

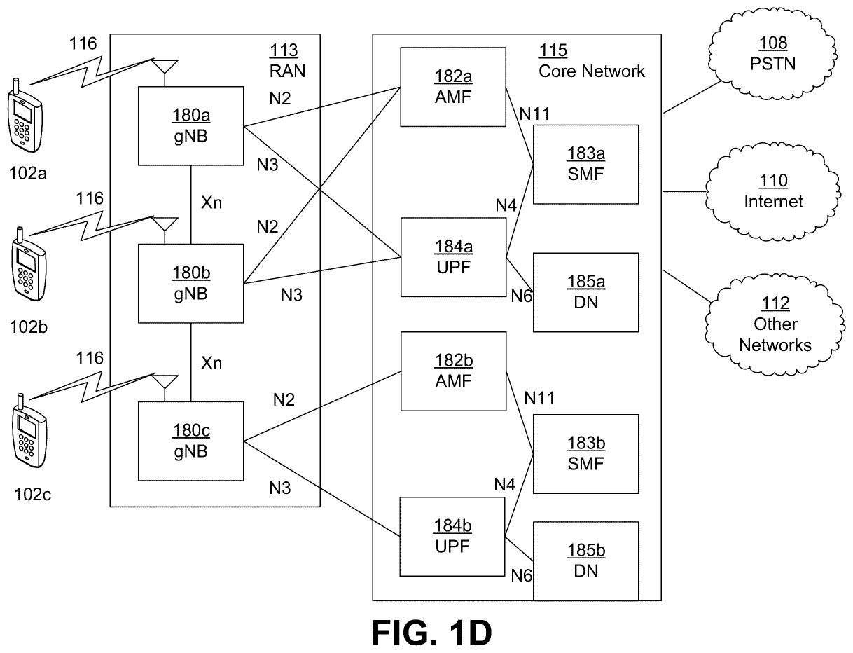

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNB, a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

It will be understood that a wireless network may include any suitable components and devices, including, for example, any of one or more base stations, one or more TRPs, one or more gNBs, one or more WTRUs, any network functions, one or more RANs, one or more application functions, one or more access and mobility management functions (AMFs), any other suitable device or component, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80 +80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, orthogonal frequency division multiplexing (OFDM) symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards AMFs 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

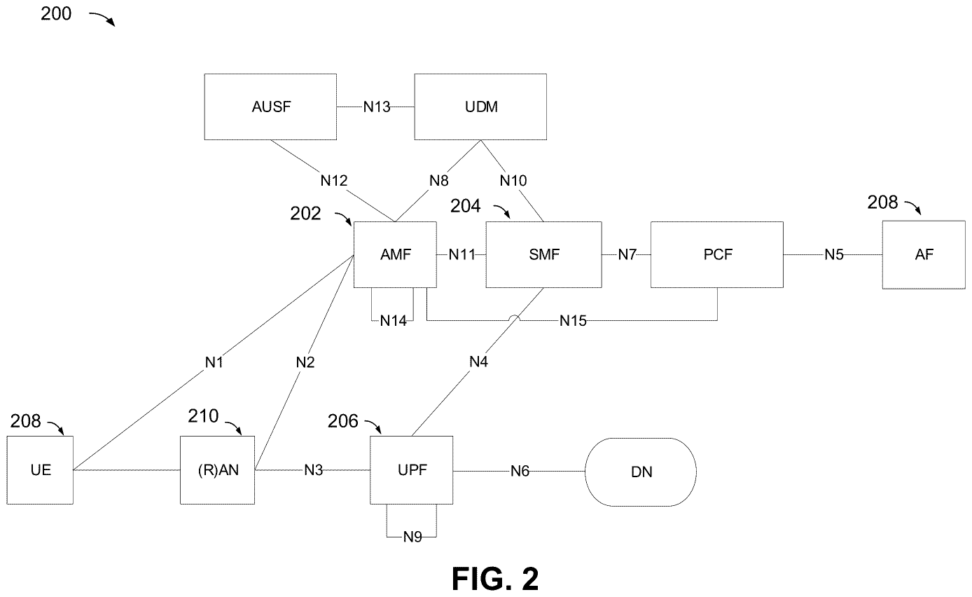

In certain embodiments of the present disclosure, including those described below at least in connection with FIGS. 2-6, the devices, systems, architectures, communication links, apparatuses, and other elements depicted in FIGS. 1A-1D may be used in connection with sensing availability evaluation of sensing entities.

FIG. 2 is a reference model of an example wireless network with which a WTRU communicates, in accordance with certain embodiments.

In accordance with certain embodiments of this disclosure, a reference model of a 5G network, or other suitable network, is shown in FIG. 2 and described as follows. FIG. 2 illustrates an example of a reference model of a network architecture (e.g., a 5G or NextGen network). In certain representative embodiments, AMF 202 (e.g., which may be the same as AMF 182a or 182b) includes the functionalities of registration management, connection management, reachability management, and mobility management. In certain representative embodiments, SMF 204 (e.g., which may be the same as SMF 183a or 183b) includes the functionalities of session management (e.g., session establishment, modification, and release), WTRU IP address allocation, selection, and control of UPFs. In certain representative embodiments, the UPF 206 (e.g., which may be the same as UPF 184a or 184b) includes the functionalities of packet routing, packet forwarding, packet inspection, and traffic usage reporting. In certain representative embodiments, the network architecture includes an application function (AF) 208 and RAN 210.

Integrated sensing may include different potential requirements for specific use cases. Integrated sensing may enhance a 5G system (5GS) such that the 5GS may better provide sensing services addressing different target verticals/applications (e.g., autonomous/assisted driving, vehicle to everything (V2X), unmanned aerial vehicles (UAVs), 3D mapping, smart city, smart home, factories, healthcare, or maritime sector applications).

In integrated sensing applications, there may be a process of collecting sensing measurement data. The sensing measurement data, for example, may be data collected about radio/wireless signals impacted (e.g., reflected, refracted, diffracted) by an object or by an environment of interest for sensing purposes. An example of generating sensing measurement data may be deriving sensing results from processing sensing measurement data. There may also be an area defined for sensing, e.g., a sensing service area (SSA) location, which may be an area or location (with or without at least one obstacle) in which the SSA can provide sensing service with target quality. Still further, for example, non-3GPP (N3GPP) entities are considered; sensing measurement data related to N3GPP entities may be considered as transparent to 5GS, such that the corresponding data may be communicated using a standard protocol to an interface defined by the 5GS. One use case for integrated sensing is object detection for a pedestrian/animal intrusion detection on a highway.

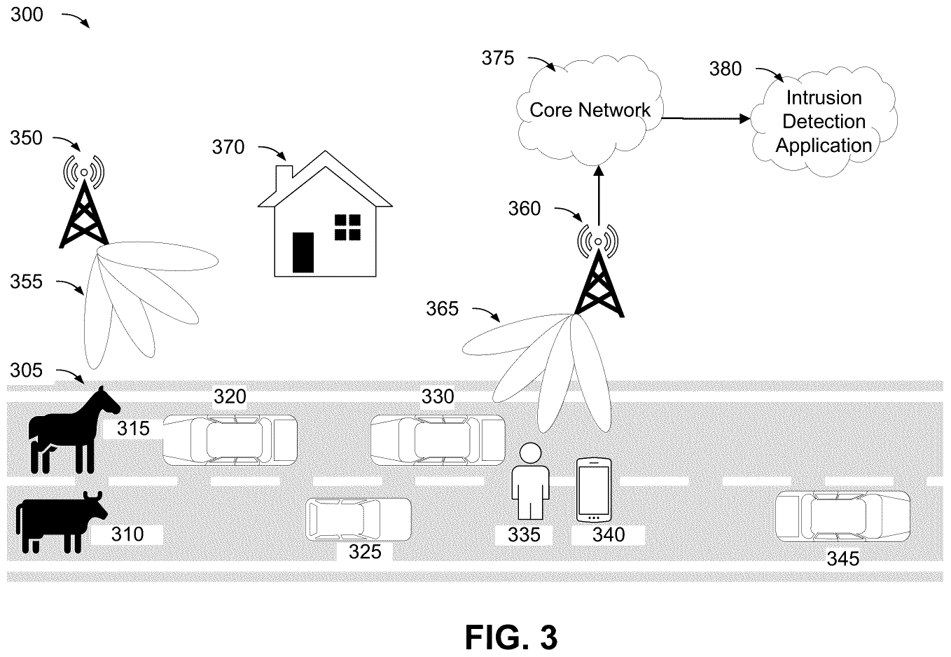

FIG. 3 is a diagram depicting an example of a pedestrian and/or animal intrusion detection, in accordance with certain embodiments.

As shown in FIG. 3, for example, in an outdoor environment 300, pedestrian and/or animal intrusion detection is provided. Environment 300 includes highway 305 and residential property 370 adjacent highway 305. Base station 350 (e.g., which may be the same as base station 114a or 114b) at a first location and base station 360 at a second location emit beams 355 and 365, respectively. Beams 355 and 365 interact with highway 305 and objects 310-345 on highway 305 such as a first animal (e.g., cow) 310, a second animal (e.g., horse) 315, first vehicle 320 traveling in a first direction (right-to-left on the page), second vehicle 325 traveling in a second direction (left-to-right) opposite the first direction, third vehicle 330 traveling in the first direction, pedestrian 335 traveling in the first direction, pedestrian 335 carrying WTRU 340 (e.g., which may be the same as WTRU 102a, 102b, 102c, or 102d), and fourth vehicle 345 traveling in the second direction. Information regarding highway 305, property 370, and objects 310-345 is transmitted by base station 360 (e.g., which may be the same as base station 114a or 114b)) to core network 375 (e.g., which may be the same as CN 106 or 115). Core network 375 transmits the information to intrusion detection application 380. Intrusion detection application 380 is configured to sense, identify, and/or track the objects 310-345, for example, with respect to base stations 350, 360 and/or one or more fixed points along highway 305 and/or property 370. Intrusion detection application 380 may be configured to differentiate between different types of vehicles (e.g., compact vehicle 325 versus large vehicle 345) or different types of objects (e.g., horse 315 versus human 335) and corresponding locations, directions of movement, velocities, or the like.

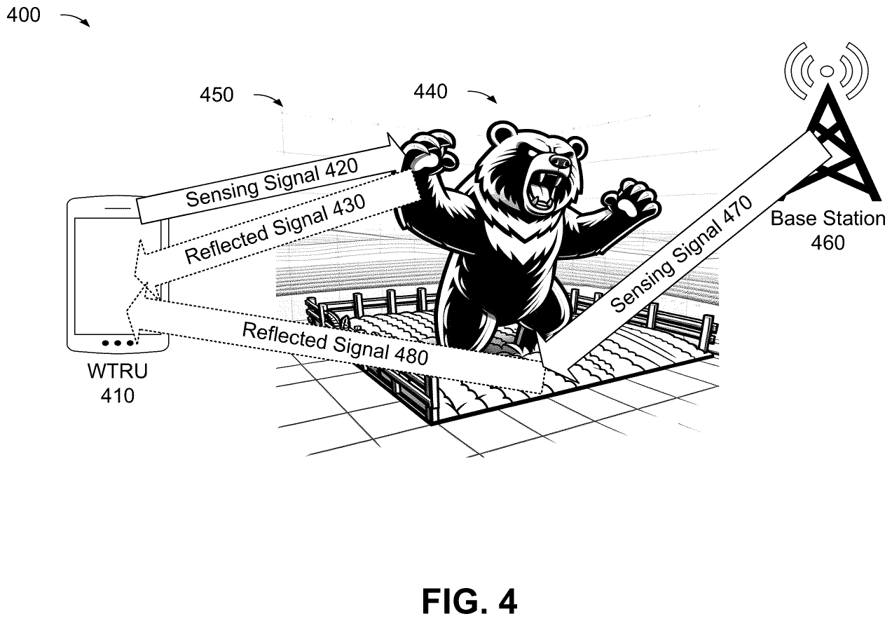

Another use case for integrated sensing is object detection for the surroundings of a smart home. FIG. 4 is a diagram depicting an example of intruder detection in surroundings of a smart home, in accordance with certain embodiments. As shown in FIG. 4, for example, in outdoor environment 400, intruder detection in surroundings 450 of a smart home is provided. Environment 400 includes WTRU 410 (e.g., which may be the same as WTRU 102a, 102b, 102c, 102d, or 340), intruder (e.g., a bear) 440, and base station 460. WTRU 410 is configured to transmit sensing signal 420, which, in this example, is incident on intruder 440. WTRU 410 is configured to receive reflected signal 430, which, in this example, reflects the sensing signal 420 after incidence with the intruder 440. Base station 460 is configured to transmit sensing signal 470, which, in this example, is incident on surroundings (e.g., the ground) 450. WTRU 410 is configured to receive reflected signal 480, which, in this example, reflects the sensing signal 470 after incidence with surroundings 450.

In the scenarios of FIG. 3 and FIG. 4, a base station (e.g., 350, 360, 460) and/or a WTRU (e.g., 340, 410) can detect the intrusion of an object (e.g., cow 310, vehicle 320, bear 440) into the sensing area of the base station by itself or by collaboration between the WTRU and the base station. For example, the sensing measurement is transferred to the core network 375 and further processed into the sensing result.

In certain embodiments, transparent sensing is another use case for integrated sensing where sensing data is captured by a WTRU and communicated so that 5GS is aware of the sensing information. The WTRU may acquire sensing measurements from different 3GPP and non- 3GPP devices. 5G core (5GC) may determine various available sensing services by processing collated sensing data.

In some approaches, an integrated sensing service provides object detection and tracking with quality of service (QoS) requirements for a sensing operation. For example, QoS for sensing operations (e.g., sensing QoS) may include accuracy of positioning estimation, accuracy of velocity estimation, range and velocity resolution, latency, confidence level, missed detection error rate, false detection error rate, combinations of the same, or the like. In one example, an unmanned aerial vehicle (UAV) is a service scenario for sensing associated with sensing operations including intrusion detection, tracking and collision avoidance, or the like.

In some integrated sensing and communication service approaches, once a sensing service is requested, a system (e.g., a wireless network) discovers and selects proper sensing entities to perform a sensing operation with one or more requested sensing QoS requirements (e.g., accuracy, granularity, latency, or the like). In some examples, periodic sensing information updates are required. For example, in weather condition monitoring scenarios such as monitoring rain and snow at a sensing service area, sensing information requires periodic updates by involved sensing entities (e.g., base stations and WTRUs) at the sensing service area. Further, for example, in intrusion detection (e.g., for smart home) scenarios, sensing entities perform periodic sensing operation to detect any possible intrusions. In such examples, once the sensing service is requested, the system (e.g., wireless network) discovers and assigns proper sensing entities (e.g., base stations and WTRUs) to a sensing group for periodic sensing operations. In such examples, assigning sensing entities to sensing group may minimize the need for sensing discovery and selection procedures before each sensing measurement operation.

However, in such integrated sensing and communication service approaches, a WTRU assigned to a sensing group may become unavailable for sensing. For example, the WTRU's availability for a sensing operation may be different at different times (e.g., based on WTRU mobility, WTRU battery condition, channel status, combinations of the same, or the like). Consequently, systems and methods for evaluating sensing availability of sensing entities are desired.

In one WTRU availability evaluation approach, a WTRU's location is considered for discovery and selection of sensing entities. However, the WTRU location as a sole selection criteria for sensing entities may not result in accurate selection of available sensing entities. For example, a distance between a sensing transmitter and a sensing receiver may not reflect environment and/or channel conditions associated with a change in WTRU availability for a sensing operation. Further, for example, WTRU availability may be associated with environment properties (e.g., rural or urban area) and/or weather conditions (e.g., high fading in raining, or the like). Moreover, for example, for higher granularity sensing operations, more detailed information may be desired for selecting sensing entities in a mobile environment.

Accordingly, systems and methods are disclosed in the present disclosure for evaluating sensing availability of sensing entities to support selection of sensing entities for sensing operations (e.g., with a requested sensing QOS). In certain representative embodiments, a WTRU (e.g., or sensing entity) may perform sensing availability evaluation coordinated by a sensing network function (NF) of a wireless network. For example, the WTRU (e.g., or any other sensing entity) may perform at least one of the following steps: receiving sensing group information (e.g., indicating a configured sensing group) and configuration information for performing sensing availability evaluation to determine internal availability information and/or external availability information; transmitting and receiving sensing reference signal for sensing availability evaluation, as configured by the sensing NF; evaluating the received sensing reference signals for conditions associated with the sensing availability evaluation; transmitting sensing availability information (e.g., a sensing availability report); receiving updates on sensing entities (e.g., updated selection of sensing entities for a sensing operation); performing a sensing operation with sensing entities coordinated by the sensing NF; combinations of the same; or the like. Further, for example, the sensing NF may perform at least one of the following steps: receiving a sensing service request; determining a sensing mode for the sensing service request; discovering sensing entities; evaluating sensing availability information from the discovered sensing entities; selecting proper sensing entities for the sensing mode for the requested sensing service; transmitting sensing group information (e.g., configuring a sensing group) and sensing availability evaluation information to the selected sensing entities; receiving sensing availability information (e.g., sensing evaluation reports) from sensing entities; updating sensing entities (e.g., selected for a sensing operation) based on the sensing availability information; coordinating a sensing operation with the selected (e.g., updated) sensing entities; transmitting sensing results to the sensing service consumer; combinations of the same; or the like.

In certain representative embodiments, a WTRU provides (e.g., periodically) a sensing availability report based on a sensing availability evaluation performed by the WTRU. For example, a WTRU may perform at least one of the following steps: receiving sensing group information (e.g., indicating a configured sensing group) and information for sensing availability evaluation to determine internal sensing availability evaluation information and external sensing availability evaluation information; monitoring an environment (e.g., of the WTRU) to determine internal and external sensing availability evaluation information; evaluating sensing availability (e.g., internal and external sensing availability of the WTRU) and verify whether the sensing availability satisfies the condition for sensing availability evaluation information (e.g., sensing evaluation report); transmitting a sensing availability evaluation report; receiving updates (e.g., selected for a particular sensing operation) on sensing entities; performing the sensing operation with sensing entities coordinated by the sensing NF. Further, for example, the sensing NF may perform at least one of the following steps: receiving a sensing service request; determining a sensing mode for the sensing service request; discovering sensing entities; evaluating sensing availability information (e.g., sensing availability reports) from discovered sensing entities; selecting proper sensing entities for a sensing mode for the requested sensing service; transmitting sensing group information (e.g., configuring the sensing group) and sensing availability evaluation information to the selected sensing entities; receiving sensing availability information (e.g., sensing availability reports) from sensing entities; updating sensing entities based on the sensing availability information; coordinating sensing operations with selected (e.g., updated) sensing entities; sending sensing results to the sensing service consumer; combinations of the same; or the like.

In the present disclosure, a sensing NF is defined for coordination of the sensing availability evaluation and/or sensing operation. The sensing NF may be a logical entity and may be collocated with other network entities (e.g., network exposure function (NEF)). The steps described as being performed by the sensing NF may be performed by any entity and/or function of the wireless network.

In accordance with certain embodiments of the present disclosure, sensing availability evaluation is described as follows.

In certain representative embodiments, when a WTRU is discovered and selected as a sensing entity or when managing a sensing group of available sensing entities for a particular sensing operation, the WTRU may perform sensing availability evaluation to determine sensing availability information. In certain representative embodiments, the sensing availability information includes internal availability information and/or external availability information. For example, internal availability information includes at least one of the following: WTRU capability information for sensing (e.g., supported sensing modes, supported operations, supported security capabilities, or the like); privacy settings (e.g., allowing or preventing sharing of sensing data to a service consumer (e.g., application function, WTRU, or the like)); connection status (e.g., idle status, connected status, or the like); battery power status; available time for sensing operation; energy consumption status; combinations of the same; or the like. In some examples, internal WTRU regulatory aspects may be considered for determining internal availability information. In one example, the internal availability information indicates that video-based sensing is prohibited for a particular area (e.g., by regulation). Further, for example, external availability information includes at least one of the following: location (e.g., geographical location, service area, or the like); channel status (e.g., number of received signals from sensing transmitters and/or channel conditions such as signal strength, delay, multipath characteristics, or the like); a registered public land mobile network (PLMN) ID; relationships to associated sensing transmitters (e.g., relative positions, ranging from sensing transmitters, or the like); combinations of the same; or the like. In some examples, external WTRU regulatory aspects may be considered for determining external availability information. In one example, the external availability information indicates an area where sensing is not allowed (e.g., by regulation).

In certain representative embodiments, after sensing availability evaluation, sensing entities are selected for a sensing group for sensing operation (e.g., based on the sensing availability information determined by the sensing availability evaluation). For example, the system (e.g., wireless network) may select one or more sensing entities for the sensing group based on the sensing availability information (e.g., internal availability information and/or external availability information). In some examples, the sensing NF may consider regulatory information when selecting the one or more sensing entities for the sensing group. In one example, the system determines that video-based sensing is not available for a particular sensing service area (e.g., by regulation), sensing entities within the sensing service area are not considered for selection to a sensing group for a sensing mode using video. In another example, the system determines that a particular sensing service area is not available for a sensing operation (e.g., by regulation), and sensing entities within the sensing service area are not considered for selection to a sensing group for the sensing operation.

In certain representative embodiments, after sensing entities for a sensing group (e.g., sensing group members) are selected, based on sensing availability information, members of the sensing group may be further updated. For example, additional discovery and selection procedures may be performed as necessary to add more sensing members based on sensing availability evaluation of discovered entities.

In certain representative embodiments, the sensing NF identifies members (e.g., sensing entities) of the sensing group as candidate sensing entities for assignment to a sensing occasion (e.g., sensing operation at a time period) based on the sensing availability information. For example, the sensing NF may assign different sensing entities among the candidate sensing entities to different sensing occasions based on the sensing availability information. In some examples, the sensing NF determines that a candidate WTRU may be involved at a first sensing occasion but not a second sensing occasion. based on the sensing availability information.

In certain representative embodiments, sensing availability evaluation of a sensing group is performed (e.g., coordinated by the sensing NF) as a one-time event or periodically. In certain representative embodiments, parameters for sensing availability evaluation are shared within a sensing group (e.g., following sensing entity discovery and/or configuration of the sensing group). For example, parameter for sensing availability evaluation may include at least one of the following: timing, list of sensing transmitters, list of sensing receivers, reference signal information (e.g., waveform, transmission power, resources, or the like); combinations of the same; or the like.

In certain representative embodiments, the WTRU (e.g., sensing entity) is configured to report its sensing availability in a periodic or event-triggered manner.

In certain representative embodiments, for sensing services requiring high granularity in accuracy, sensing resolution, or the like, relative positioning among sensing receivers and sensing transmitters (e.g., of a sensing group) is important for selection of proper sensing entities. In some examples, the relative positioning may be determined based on comparing channel conditions of the sensing receivers and sensing transmitters (e.g., as opposed to comparing each entity's location information). In certain representative embodiments, dynamic sensing availability evaluation coordinated by sensing NF is performed, where the sensing NF coordinates an event to monitor sensing reference signals from each sensing transmitter. In such embodiments, based on channel measurement result from each sensing receiver, the sensing NF evaluates relative positioning among the sensing receivers and sensing transmitters and selects the proper sensing entities for the operation.

In certain representative embodiments, after discovery and selection of sensing entities for a sensing operation, the sensing NF may identify multiple sensing groups as candidates for the sensing operation. In some embodiments, after receiving the sensing availability information for a sensing occasion, the sensing NF may select a proper sensing group from the multiple candidate sensing groups for the sensing operation. In one example, the sensing NF may identify candidate sensing groups 1-3 based on criteria associated with the sensing operation and/or sensing service. In this example, the system determines sensing group 1 to be the most preferred sensing group and sensing group 3 to be the least preferred sensing group based on the criteria. After evaluating the sensing availability information from sensing group 1, if some sensing entities of sensing group 1 are not available for the sensing operation, the sensing NF may select the next best sensing group (e.g., sensing group 2) based on sensing entity availability.

In accordance with certain embodiments of the present disclosure, sensing availability evaluation coordinated by the sensing NF is described as follows.

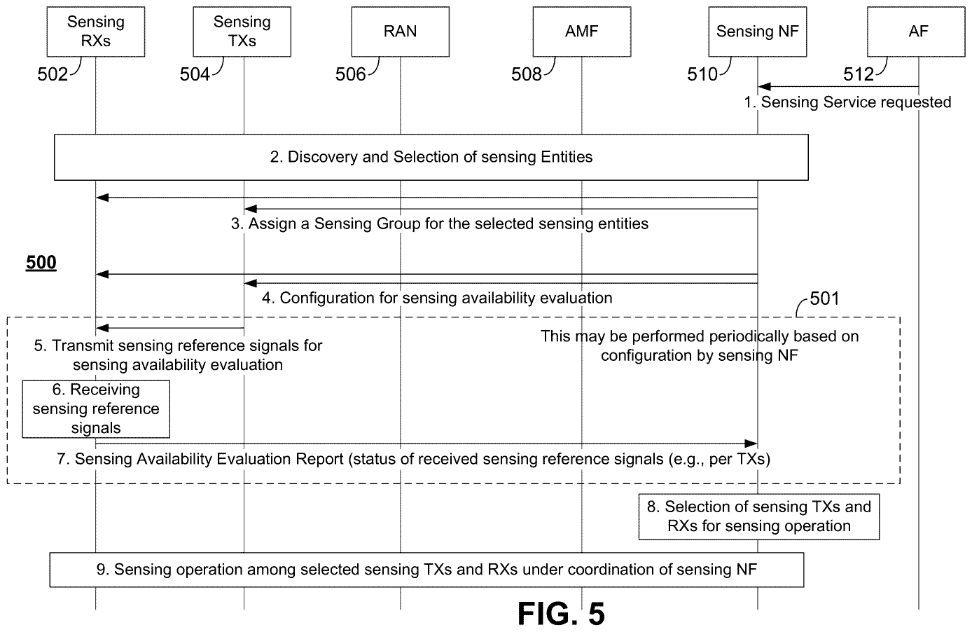

FIG. 5 is a flowchart of an illustrative method 500 for evaluating sensing availability of sensing entities. As shown in FIG. 5, in some embodiments, the illustrative method 500 includes steps performed by at least one of the following: sensing receivers 502 (e.g., WTRU 102 of FIGS. 1A-1D, WTRU 208 of FIG. 2, WTRU 340 of FIG. 3, WTRU 410 of FIG. 4, or the like); sensing transmitters 504 (e.g., WTRU 102 of FIGS. 1A-1D, WTRU 208 of FIG. 2, WTRU 340 of FIG. 3, WTRU 410 of FIG. 4, or the like); RAN 506 (e.g., RAN 104 and 113 of FIGS. 1A-1D, RAN 210 of FIG. 2); AMF 508 (e.g., AMF 182a and 182b of FIGS. 1A-1D, AMF 202 of FIG. 2, or the like); sensing NF 510; AF 512 (e.g., AF 208 of FIG. 2), combinations of the same; or the like.

At step 1, the AF 512 sends a sensing service request to sensing NF 510.

At step 2, the sensing NF 510 discovers sensing transmitters 502 and sensing receivers 504 based on determining a sensing mode for the received sensing service request. In some embodiments, the sensing NF selects proper sensing transmitters 502 and sensing receivers 504 based on sensing availability evaluation results. For example, the sensing NF 510 may perform discovery and selection of sensing entities in coordination with at least one of the following: sensing receivers 502, sensing transmitters 504, RAN 506, AMF 508, combinations of the same, or the like.

In some embodiments, during discovery and selection of sensing entities, the sensing NF 510 requests a sensing availability evaluation report from the candidate sensing entities (e.g., selected from discovered sensing entities based on criteria for the sensing service and/or operation). For example, the sensing NF 510 may request sensing availability evaluation to determine internal availability information and/or external availability information. Further, for example, based on the sensing availability information received from candidate sensing entities, the sensing NF 510 may select sensing entities for the sensing operation (e.g., for the requested sensing service).

At step 3, the sensing NF 510 assigns a sensing group to the selected sensing entities (e.g., sensing transmitters 504 and sensing receivers 502). For example, the sending NF 510 may assign sensing receivers 502 and sensing transmitters 504 to a first sensing group for a sensing operation.

At step 4, the sensing NF 510 transmits configuration information for sensing availability evaluation (e.g., periodic sensing availability evaluation, event-triggered sensing availability evaluation, or the like). For example, the sensing NF 510 may transmit the configuration information to each sensing group or for particular sensing entities of a sensing group. Further, for example, the sensing NF 510 may include in the configuration information any information needed for sensing availability evaluation. Moreover, for example, the configuration information may include at least one of the following: a time period, reference signals for transmission by sensing transmitters 504, measurements results requested from sensing receivers 502 (e.g., number of received signals from sensing transmitters 504, signal strength, delay, or the like), combinations of the same, or the like.

In certain representative embodiments, at box 501, steps 5-7 are performed periodically based on the configuration information transmitted by the sensing NF 510. In some embodiments, steps 5-7 may be performed based on identification of an event trigger indicated by the configuration information transmitted by the sensing NF 510.

At step 5, based on the configuration information transmitted by the sensing NF 510, the sensing transmitters 504 transmit one or more sensing reference signals for sensing availability evaluation. For example, the sensing transmitters 504 transmit the one or more sensing reference signals at a configured time. Further, for example, the sensing transmitters 504 transmit the one or more sensing reference signals with a configured reference signal waveform. Moreover, for example, the sensing transmitters 504 transmit the one or more sensing reference signals with a configured transmission power.

At step 6, the sensing receivers 502 receive the one or more sensing reference signals based on the configuration information 520 transmitted by the sensing NF 510.

At step 7, the sensing receivers 502 send a sensing availability evaluation report after receiving the sensing reference signals. For example, the sensing availability evaluation report includes internal availability information and/or external availability information. Further, for example, the sensing availability evaluation report includes the status of received sensing reference signals (e.g., for each sensing transmitter). Moreover, for example, the internal availability information may include at least one of: an indication of battery power status (e.g., low battery power); an indication of resource availability (e.g., low resource available for communication); a connection mode (e.g., idle state, active power saving mode, or the like); combinations of the same; or the like. Also, for example, the external availability information may include at least one of: an indication of channel status (e.g., sensing receivers 502 cannot receive signals from sensing transmitters 504); an indication of location (e.g., geographical coordinate, sensing receivers 502 moved out of sensing service area); an indication of frequency; PLMN information; combinations of the same; or the like. In some examples, based on the sensing availability evaluation, the sensing receivers 502 may indicate (e.g., within the sensing availability evaluation report) its unavailability as sensing entities for a requested sensing occasion (e.g., a sensing operation at a time).

At step 8, the sensing NF 510 selects (e.g., reselects) sensing transmitters 504 and sensing receivers 502 for a sensing occasion based on the received sensing availability evaluation report. In one example, based on the sensing availability evaluation report, a first sensing receiver is determined to be moving away from a sensing transmitter, and the sensing NF 510 may select a second sensing receiver determined to be close to the first sensing receiver (e.g., but is not moving away from the sensing transmitter) to replace the first sensing receiver for a sensing operation. In some examples, when the sensing receiver does not receive a sensing reference signal from the sensing transmitter, the sensing transmitter may be determined to be out of the sensing area. In some embodiments, the sensing receivers 502 are configured to send the sensing availability evaluation report when the number of received sensing signals is more than a configured threshold (e.g., minimum number of signals or the like). In some embodiments, the sensing receivers 502 may be configured to send the sensing availability evaluation report when the signal strength of received sensing signals is more than a configured threshold (e.g., minimum signal strength or the like). In some examples, if the sensing NF 510 does not receive a report from a sensing receiver, the sensing NF 510 may consider the sensing receiver out of coverage and drop it from a sensing operation and/or sensing group.

In some embodiments, the sensing transmitters 504 are gNBs and sensing receivers 502 are WTRUs. In such embodiments, several WTRUs may be updated to become new sensing receivers. In some embodiments, the sensing transmitters 504 are WTRUs. In such embodiments, several WTRUs may be updated to become new sensing transmitters and other sensing entities (e.g., WTRUs and/or gNBs) may be updated to become new sensing receivers.

At step 9, based on coordination by the sensing NF 510, the sensing transmitters 504 and the sensing receivers 502 perform the sensing operation. For example, the sensing NF 510 transmits sensing configuration information to the sensing transmitters 504 and sensing receivers 502 for performing the sensing operation. Further, for example, the sensing receivers 502 transmit sensing measurement reports to the sensing NF 510 or a sensing processing entity (e.g., of the wireless network) in coordination with the sensing NF 510.

In accordance with certain embodiments of the present disclosure, sensing availability reporting by a WTRU is described as follows.

In certain representative embodiments, based on configuration information received from the wireless network, the WTRU periodically reports its availability as a sensing entity. In certain representative embodiments, based on configuration information received from the wireless network, the WTRU reports its availability as a sensing entity when an event is triggered. In certain representative embodiments, based on configuration information received from the wireless network, the WTRU reports its availability as a sensing entity as a one-time event upon receiving a request from the sensing NF.

In certain representative embodiments, after the sensing group is formed, every sensing entity (e.g., of the sensing group) is requested to report its status periodically or based on an event trigger (e.g., when the WTRU leaves a sensing service area). For example, based on configuration information or additional indications from the sensing NF, each sensing receiver may monitor available sensing transmitters in the sensing group. Further, for example, each sensing receiver may monitor signals from other sensing transmitters (e.g., not in the sensing group).

In certain representative embodiments, the sensing availability report is event-triggered and if monitored channel characteristics satisfy one or more conditions, the WTRU sends the sensing availability report. For example, the one or more conditions may include the signal strength of a monitored transmitter being below a threshold for some configured time period. Further, for example, the sensing availability report may include the monitored environment information (e.g., the received signal strength from each sensing transmitter).

In certain representative embodiments, based on the sensing availability information received from each sensing receiver, the sensing NF selects the proper sensing receivers for a sensing operation before coordinating the actual sensing operation.

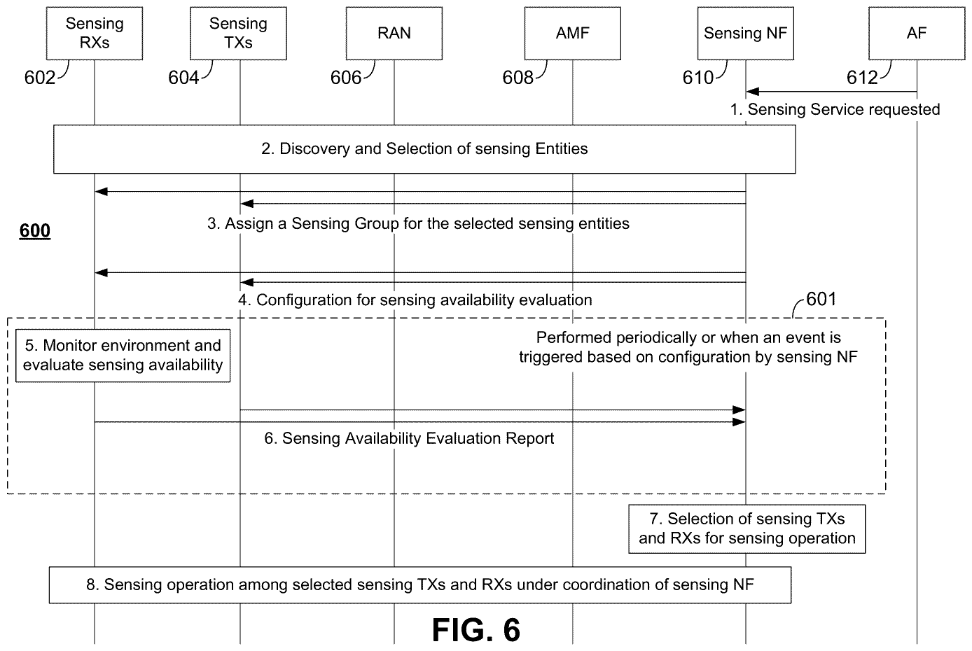

FIG. 6 is a flowchart of an illustrative method for evaluating sensing availability of sensing entities, in accordance with certain embodiments. As shown in FIG. 6, in some embodiments, the illustrative method 600 includes steps performed by at least one of the following: sensing receivers 602 (e.g., WTRU 102 of FIGS. 1A-1D, WTRU 208 of FIG. 2, WTRU 340 of FIG. 3, WTRU 410 of FIG. 4, or the like); sensing transmitters 604 (e.g., WTRU 102 of FIGS. 1A-1D, WTRU 208 of FIG. 2, WTRU 340 of FIG. 3, WTRU 410 of FIG. 4, or the like); RAN 606 (e.g., RAN 104 and 113 of FIGS. 1A-1D, RAN 210 of FIG. 2); AMF 608 (e.g., AMF 182a and 182b of FIGS. 1A-1D, AMF 202 of FIG. 2, or the like); sensing NF 610; AF 612 (e.g., AF 208 of FIG. 2), combinations of the same; or the like.

At step 1 (e.g., of FIG. 6), the AF 612 transmits a sensing service request to the sensing NF 610.

At step 2, the sensing NF 610 discovers sensing transmitters 604 and sensing receivers 602 based on determining a sensing mode for the received sensing service request 614. In some embodiments, the sensing NF 610 selects proper sensing transmitters 604 and sensing receivers 602 based on sensing availability evaluation results. For example, the sensing NF 610 may perform discovery and selection of sensing entities in coordination with at least one of the following: sensing receivers 602, sensing transmitters 604, RAN 606, AMF 608, AF 612, combinations of the same, or the like.

At step 3, the sensing NF 610 assigns a sensing group to the selected sensing entities (e.g., sensing transmitters 604 and sensing receivers 602). In one example, the sensing NF 610 assigns the sensing receivers 602 and the sensing transmitters 604 to a first sensing group for a sensing operation (e.g., of a sensing service).

At step 4, the sensing NF 610 configures sensing receivers 602 and sensing transmitters 604 to provide sensing availability evaluation in a periodic or event-triggered manner. For example, the sensing NF 610 transmits configuration information indicating time periods for periodic reporting of sensing availability information. Further, for example, the sensing NF 610 transmits configuration information indicating trigger conditions for event-triggered reporting of sensing availability information. In one example, the trigger conditions include a threshold of signal strength for a monitored channel. Moreover, for example, the configuration information may include conditions for internal evaluation (e.g., threshold for battery level, threshold for monitored energy consumption amount/level, computing power, combinations of the same, or the like).

In certain representative embodiments, at box 601, steps 5-6 are performed periodically based on the configuration information transmitted by the sensing NF 610. In some embodiments, steps 5-6 may be performed based on identification of a satisfied trigger condition indicated by the configuration information transmitted by the sensing NF 510.

At step 5, the sensing receivers monitor the channel environment based on the configuration information 620 received from the sensing NF 610.

At step 6, the sensing receivers 602 send sensing availability evaluation reports periodically or when an event is triggered based on the configuration information transmitted by the sensing NF 610. For example, the sensing availability evaluation report includes internal availability information and/or external availability information. Further, for example, the sensing availability evaluation report includes the status of received sensing reference signals (e.g., for each sensing transmitter). Moreover, for example, the internal availability information may include at least one of: an indication of battery power status (e.g., low battery power, battery power below threshold, or the like); an indication of resource availability (e.g., low resource available for communication, available resources below threshold, or the like); a connection mode (e.g., idle state, active power saving mode, or the like); combinations of the same; or the like. Also, for example, the external availability information may include at least one of: an indication of channel status (e.g., sensing receivers 602 cannot receive signals from sensing transmitters 604, received signal strength is below threshold for a time period, or the like); an indication of location (e.g., geographical coordinate, sensing receivers 602 moved out of sensing service area); an indication of frequency; PLMN information; combinations of the same; or the like. In some examples, based on the sensing availability evaluation, the sensing receivers 602 may indicate (e.g., within the sensing availability evaluation report) its unavailability as sensing entities for a requested sensing occasion (e.g., a sensing operation at a time). Further, for example, sensing transmitters 604 may send sensing availability evaluation reports periodically or when an event (e.g., power failure, overload, or the like) is triggered based on the configuration information 620 transmitted by sensing NF 610.

At step 7, the sensing NF 610 may select (e.g., reselect) sensing transmitters 604 and sensing receivers 602 for a sensing occasion based on the received sensing availability evaluation reports. In one example, based on the sensing availability evaluation reports, the sensing NF 610 determines that a first sensing receiver is moving away from a sensing transmitter and selects a second sensing receiver (e.g., of the sensing group) that is close to the first sensing receiver (e.g., but not moving away from the sensing transmitter) to replace the first sensing receiver for the sensing operation. In some examples, when the sensing receiver does not receive a sensing reference signal from the sensing transmitter, the sensing transmitter may be determined to be out of the sensing area. In some examples, if the sensing NF 610 does not receive a report from a sensing receiver, the sensing NF 610 may consider the sensing receiver out of coverage and drop it from a sensing operation and/or sensing group.

In some embodiments, the sensing transmitters 604 are gNBs and sensing receivers 602 are WTRUs. In such embodiments, several WTRUs may be updated to become new sensing receivers. In some embodiments, the sensing transmitters 604 are WTRUs. In such embodiments, several WTRUs may be updated to become new sensing transmitters and other sensing entities (e.g., WTRUs and/or gNBs) may be updated to become new sensing receivers.

At step 8, based on coordination by the sensing NF 610, the sensing transmitters 604 and the sensing receivers 602 perform the sensing operation. For example, the sensing NF 610 transmits sensing configuration information to the sensing transmitters 604 and sensing receivers 602 for performing the sensing operation. Further, for example, the sensing receivers 602 transmit sensing measurement reports to the sensing NF 610 or a sensing processing entity (e.g., of the wireless network) in coordination with the sensing NF 610.

In accordance with certain embodiments of the present disclosure, wireless network-based sensing availability management is described as follows.

In certain representative embodiments, the sensing NF may manage sensing availability based on status information received from network functions and/or gNBs. For example, the sensing NF may subscribe a service provided by an NF serving WTRUs or a gNB. Further, for example, to detect a WTRU's location(e.g., detect a WTRU moving out of the sensing service area), the sensing NF may subscribe to a location event service from WTRUs serving the AMF, gNB, gateway mobile location center (GMLC), location management function (LMF), any other entity (e.g., wireless network entity), or the like. Moreover, for example, to detect a WTRU connection status, the sensing NF may subscribe to a service for connection mode change reporting (e.g., change to Idle state, change to radio resource control (RRC) Inactive or RRC Idle state).

In certain representative embodiments, when a sensing entity (e.g., WTRU) does not respond to a request (e.g., from the sensing NF), the sensing NF sends a request for the sensing entity's status information (e.g., connection mode, protocol data unit (PDU) session mode, or the like) to other network functions. For example, based on the received information (e.g., sensing entity's status information), the sensing NF may decide to update the sensing group. Further, for example, the sensing NF may update the sensing group by performing discovery and selection of new sensing entities and/or by dropping some sensing entities from the sensing group.

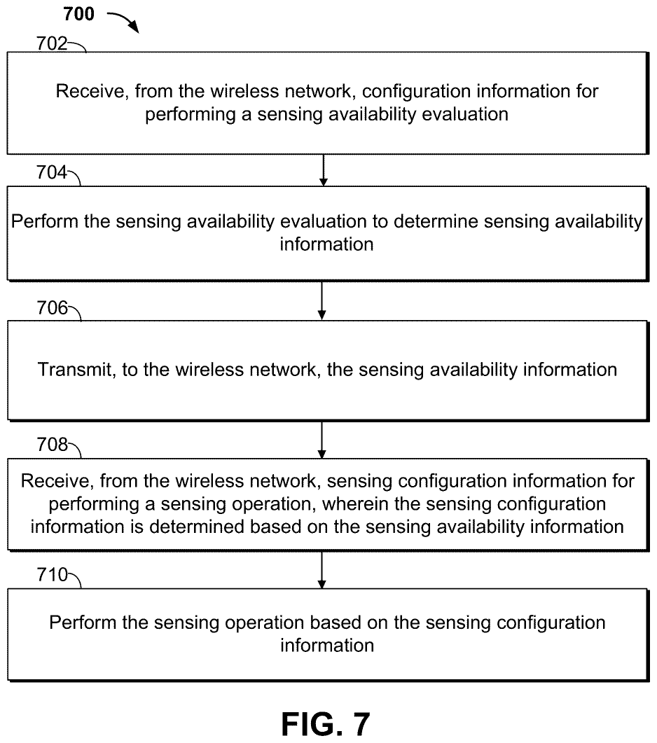

In certain representative embodiments, as shown in FIG. 7, a process 700 is performed by a WTRU (e.g., WTRU 102 of FIGS. 1A-1D, sensing entities 502 and 504 of FIG. 5), sensing entities 602 and 604 of FIG. 6) in connection with a wireless network (e.g., RAN 104 and 113 of FIGS. 1A-D and/or core network 106 and 115 of FIGS. 1A-1D), which may be implemented in communications system 100 illustrated in FIG. 1A-1D. In some embodiments, the wireless network may include and/or be associated with at least one of: sensing receivers (e.g., sensing receivers 502 and 602 of FIGS. 5-6); sensing transmitters (e.g., sensing transmitters 504 and 604 of FIGS. 5-6); a RAN (e.g., RAN 104 and 113 of FIGS. 1A-1D, RAN 506 and 606 of FIGS. 5-6); an AMF (e.g., AMF 182a and 182b of FIGS. 1A-1D, AMF 202 of FIG. 2, AMF 508 and 608 of FIGS. 5-6); a sensing NF (e.g., sensing NF 510 and 610 of FIGS. 5-6); an AF (e.g., AF 512 and 612 of FIGS. 5-6); combinations of the same; or the like.

At step 702 (e.g., step 4 of FIGS. 5-6), the WTRU receives, from the wireless network, configuration information for performing a sensing availability evaluation. In some embodiments, the WTRU receives the configuration information from a sensing NF of the wireless network. For example, the configuration information may indicate at least one of: time period information; reference signals information (e.g., for transmission by sensing transmitters); measurement information (e.g., number of received signals from sensing transmitters, signal strength, delay, or the like); reporting information (e.g., periodic, event-triggered); combinations of the same, or the like. In some embodiments, the WTRU receives the configuration information based on being selected as part of a sensing group (e.g., for a sensing service, sensing mode, and/or sensing operation).

At step 704 (e.g., steps 5-6 of FIG. 5, step 5 of FIG. 6), the WTRU performs the sensing availability evaluation to determine sensing availability information. In some embodiments, the WTRU is a sensing entity associated with a sensing group and performing the sensing availability evaluation to determine the sensing availability information includes receiving, from another sensing entity associated with the sensing group, one or more sensing reference signals associated with the sensing availability evaluation. In some embodiments, performing the sensing availability evaluation to determine the sensing availability information additionally includes performing one or more measurements of the one or more sensing reference signals. In some embodiments, the one or more measurements (e.g., and/or analyses thereof) are included in the sensing availability information. For example, the WTRU is a sensing receiver of the sensing group for a particular sensing service, and the another sensing entity is a sensing transmitter of the same sensing group. In some examples, the another sensing entity may be a sensing transmitter of a different sensing group. In some embodiments, performing the sensing availability evaluation to determine the sensing availability information includes monitoring an environment of the WTRU (e.g., periodically or based on identifying trigger conditions). For example, the WTRU determines sensing availability information (e.g., a sensing availability evaluation report) based on measurements performed and/or other determinations made during the monitoring of the environment.

At step 706 (e.g., step 7 of FIG. 5, step 6 of FIG. 6), the WTRU transmits, to the wireless network, the sensing availability information. In some embodiments, the sensing availability information is internal information that indicates at least one of the following: battery power status information; resource availability information; connection mode information (e.g., idle status, connected status, or the like); sensing capability information (e.g., supported sensing modes, supported operations, supported security capabilities or the like); privacy setting information settings (e.g., allowing or preventing sharing of sensing data to a service consumer); internal WTRU regulatory information; (e.g., indicating video-based sensing is prohibited for a particular area); combinations of the same; or the like. In some embodiments, the sensing availability information is external information that indicates at least one of the following: channel status information status (e.g., number of received signals from sensing transmitters and/or channel conditions such as signal strength, delay, multipath characteristics, or the like); location information (e.g., geographical location, service area, or the like); frequency information; PLMN information (e.g., a PLMN ID); external WTRU regulatory information (e.g., indicating an area where sensing is not allowed); combinations of the same; or the like. In some embodiments, the WTRU transmits the sensing availability information periodically based on the configuration information (e.g., indicating a time period). In some embodiments, the WTRU transmits the sensing availability information based on identifying an event trigger indicated by the configuration information (e.g., that a trigger condition of the configuration information has been satisfied). For example, the event trigger may correspond to exceeding a threshold signal strength for a monitored channel.

At step 708 (e.g., step 9 of FIG. 5, step 8 of FIG. 6), the WTRU receives, from the wireless network, sensing configuration information for performing a sensing operation, wherein the sensing configuration information is determined based on the sensing availability information. In some embodiments, the received sensing configuration information is associated with a sensing group. In such embodiments, the sensing group may be selected (e.g., by the sensing NF of the wireless network), based on the sensing availability information, from a plurality of candidate sensing groups for performing the sensing operation. For example, the candidate sensing groups may be selected based on one or more criteria associated with the sensing service, mode, and/or operation. Further, for example, the sensing group may be selected based on a preferred sensing group being associated with sensing availability information that indicates one or more unavailable sensing entities. In some embodiments, the WTRU is assigned to the sensing group based on the sensing availability information.

At step 710 (e.g., step 9 of FIG. 5, step 8 of FIG. 6), the WTRU performs the sensing operation based on the sensing configuration information. For example, the WTRU performs the sensing operation with one or more sensing entities of a sensing group, where the one or more sensing entities were selected by the wireless network (e.g., the sensing NF of the wireless network) based on the sensing availability information. Further, for example, the one or more sensing entities of the sensing group may be a subset of the plurality of sensing entities of a sensing group or may include new sensing entities selected to be included in the sensing group based on the sensing availability information. Further, for example, the WTRU may return to step 702 upon receiving new configuration information for performing sensing availability evaluation from the wireless network. Moreover, for example, the WTRU may return to step 704 based on the configuration information indicating periodic sensing availability evaluation and/or event-triggered sensing availability evaluation.

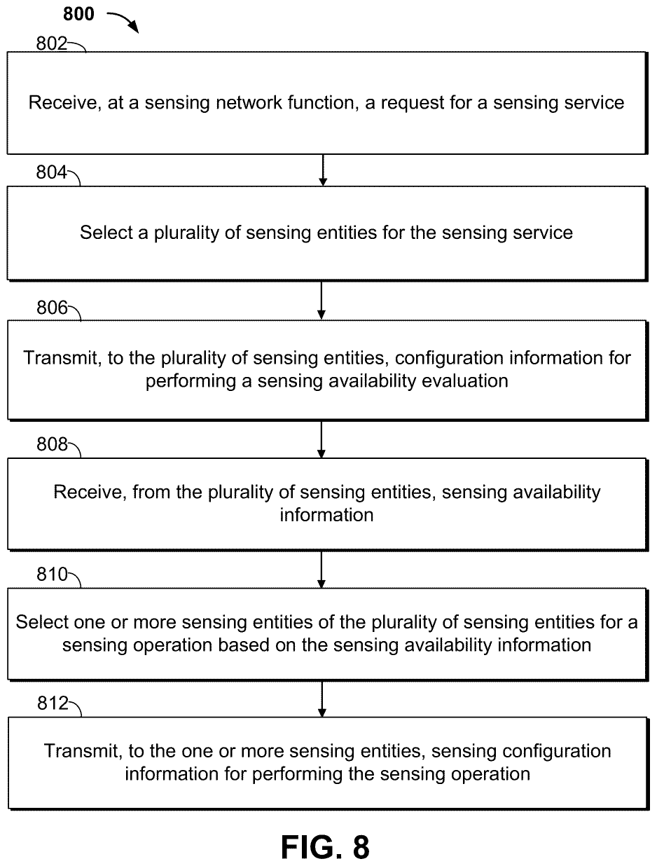

In certain representative embodiments, as shown in FIG. 8, a process 800 is performed by a wireless network (e.g., RAN 104 and 113 of FIGS. 1A-1D and/or core network 106 and 115 of FIGS. 1A-1D) in connection with a WTRU (e.g., WTRU 102 of FIGS. 1A-D, sensing entities 502 and 504 of FIG. 5, sensing entities 602 and 604 of FIG. 6), which may be implemented in communications system 100 illustrated in FIG. 1A-1D. In some embodiments, the wireless network may include and/or be associated with at least one of: sensing receivers (e.g., sensing receivers 502 and 602 of FIGS. 5-6); sensing transmitters (e.g., sensing transmitters 504 and 604 of FIGS. 5-6); a RAN (e.g., RAN 104 and 113 of FIGS. 1A-1D, RAN 506 and 606 of FIGS. 5-6); an AMF (e.g., AMF 182a and 182b of FIGS. 1A-1D, AMF 202 of FIG. 2, AMF 508 and 608 of FIGS. 5-6); a sensing NF (e.g., sensing NF 510 and 610 of FIGS. 5-6); an AF (e.g., AF 512 and 612 of FIGS. 5-6); combinations of the same; or the like.

At step 802 (e.g., step 1 of FIGS. 5-6), the wireless network receives, at a sensing NF, a request for a sensing service. For example, the request may be for a weather monitoring service. Further, for example, the request for the sensing service may be transmitted by an application function of the wireless network.

At step 804 (e.g., step 2 of FIGS. 5-6), the wireless network selects a plurality of sensing entities for the sensing service. For example, the selection of the plurality of sensing entities may occur as part of or immediately after a sensing entity discovery process. Further, for example, the sensing entity discover process and/or sensing entity selection for the sensing service may be performed across at least one of the following: sensing receivers associated with the wireless network, sensing transmitters associated with the wireless network, a RAN of the wireless network, an AMF of the wireless network, a sensing NF of the wireless network, combinations of the same, or the like. In some embodiments, the wireless network determines a sensing mode based on the sensing service and selects the plurality of sensing entities based on the sensing mode. In some embodiments, the wireless network selects the plurality of sensing entities and assigns the plurality of sensing entities to a sensing group for a particular sensing service, mode and/or operation.

At step 806 (e.g., step 4 of FIGS. 5-6), the wireless network transmits, to the plurality of sensing entities, configuration information for performing a sensing availability evaluation. For example, the configuration information may indicate at least one of: time period information; reference signals information (e.g., for transmission by sensing transmitters); measurement information (e.g., number of received signals from sensing transmitters, signal strength, delay, or the like); reporting information (e.g., periodic, event-triggered); combinations of the same, or the like. In some embodiments, the wireless network transmits the configuration information to the plurality of sensing entities based on being selected as part of a sensing group (e.g., for a sensing service, sensing mode, and/or sensing operation).

At step 808 (e.g., step 7 of FIG. 5, step 6 of FIG. 6), the wireless network receives, from the plurality of sensing entities, sensing availability information. In some embodiments, the sensing availability information is internal information that indicates at least one of the following: battery power status information; resource availability information; connection mode information (e.g., idle status, connected status, or the like); sensing capability information (e.g., supported sensing modes, supported operations, supported security capabilities or the like); privacy setting information settings (e.g., allowing or preventing sharing of sensing data to a service consumer); internal WTRU regulatory information; (e.g., indicating video-based sensing is prohibited for a particular area); combinations of the same; or the like. In some embodiments, the sensing availability information is external information that indicates at least one of the following: channel status information status (e.g., number of received signals from sensing transmitters and/or channel conditions such as signal strength, delay, multipath characteristics, or the like); location information (e.g., geographical location, service area, or the like); frequency information; PLMN information (e.g., a PLMN ID); external WTRU regulatory information (e.g., indicating an area where sensing is not allowed); combinations of the same; or the like. In some embodiments, the wireless network receives the sensing availability information periodically based on the configuration information (e.g., indicating a time period).

At step 810 (e.g., step 8 of FIG. 5, step 7 of FIG. 6), the wireless network selects one or more sensing entities of the plurality of sensing entities for a sensing operation based on the sensing availability information. In some embodiments, the wireless network (e.g., at the sensing NF) determines sensing availability of each of the plurality of sensing entities (e.g., of the sensing group) based on the sensing availability information. In some embodiments, the wireless network may select one candidate sensing group over another candidate sensing group for a sensing operation based on the number of available sensing entities in each candidate sensing group. In some embodiments, the wireless network selects one or more sensing entities (e.g., a subset) of the plurality of sensing entities for a sensing operation based on the sensing availability of each of the plurality of sensing entities.

At step 812 (e.g., step 9 of FIG. 5, step 8 of FIG. 6), the wireless network transmits, to the one or more sensing entities, sensing configuration information for performing the sensing operation. For example, the wireless network may return to step 802 upon receiving a new request for a new sensing service. Further, for example, the wireless network may return to step 808 based on receiving, from the plurality of sensing entities, new sensing availability information.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method performed by a wireless transmit/receive unit (WTRU) in communication with a wireless network, the method comprising:
receiving, from the wireless network, configuration information for performing a sensing availability evaluation;
performing the sensing availability evaluation to determine sensing availability information;
transmitting, to the wireless network, the sensing availability information;
receiving, from the wireless network, sensing configuration information for performing a sensing operation, wherein the sensing configuration information is determined based on the sensing availability information; and
perform the sensing operation based on the sensing configuration information.

2. The method of claim 1, wherein:
the WTRU is a sensing entity associated with a sensing group; and
performing the sensing availability evaluation to determine the sensing availability information comprises:
receiving, from another sensing entity associated with the sensing group, one or more sensing reference signals associated with the sensing availability evaluation; and
performing one or more measurements of the one or more sensing reference signals, wherein the sensing availability information comprises the one or more measurements.

3. The method of claim 1, wherein the sensing availability information is internal information that indicates at least one of the following:
battery power status information;
resource availability information;
connection mode information;
sensing capability information;
privacy setting information; or
internal WTRU regulatory information.

4. The method of claim 1, wherein the sensing availability information is external information that indicates at least one of the following:
channel status information;
location information;
frequency information;
public land mobile network (PLMN) information; or
external WTRU regulatory information.

5. The method of claim 1, wherein the received sensing configuration information is associated with a sensing group selected, based on the sensing availability information, from a plurality of candidate sensing groups for performing the sensing operation.

6. The method of claim 1, wherein the WTRU is assigned to a sensing group for a sensing service based on the sensing availability information.

7. The method of claim 1, wherein the sensing availability information is transmitted periodically based on the configuration information.

8. The method of claim 1, wherein transmitting the sensing availability information is based on identifying an event trigger indicated by the configuration information.

9. The method of claim 1, wherein the configuration information for performing the sensing availability evaluation indicates at least one of:
time period information;
reference signal information;
measurement information; or
reporting information.

10. The method of claim 1, wherein performing the sensing availability evaluation to determine the sensing availability information comprises monitoring an environment of the WTRU.

11. A wireless transmit/receive unit (WTRU) in communication with a wireless network, the WTRU comprising:
a processor; and
a transceiver coupled to the processor, wherein the WTRU is configured to:
receive, from the wireless network, configuration information for performing a sensing availability evaluation;
perform the sensing availability evaluation to determine sensing availability information;
transmit, to the wireless network, the sensing availability information;
receive, from the wireless network, sensing configuration information for performing a sensing operation; and
perform the sensing operation based on the sensing configuration information.

12. The WTRU of claim 11, wherein:
the WTRU is a sensing entity associated with a sensing group; and
the WTRU is configured to perform the sensing availability evaluation to determine the sensing availability information by:
receiving, from another sensing entity associated with the sensing group, one or more sensing reference signals associated with the sensing availability evaluation; and
performing one or more measurements of the one or more sensing reference signals, wherein the sensing availability information comprises the one or more measurements.

13. The WTRU of claim 11, wherein the sensing availability information is internal information that indicates at least one of the following:
battery power status information;
resource availability information;
connection mode information;
sensing capability information;
privacy setting information; or
internal WTRU regulatory information.

14. The WTRU of claim 11, wherein the sensing availability information is external information that indicates at least one of the following:
channel status information;
location information;
frequency information;
public land mobile network (PLMN) information; or
external WTRU regulatory information.

15. The WTRU of claim 11, wherein the received sensing configuration information is associated with a sensing group selected, based on the sensing availability information, from a plurality of candidate sensing groups for performing the sensing operation.

16. The WTRU of claim 11, wherein the WTRU is assigned to a sensing group for a sensing service based on the sensing availability information.

17. The WTRU of claim 11, wherein the sensing availability information is transmitted periodically based on the configuration information.

18. The WTRU of claim 11, wherein the WTRU is configured to transmit the sensing availability information based on identifying an event trigger indicated by the configuration information.

19. The WTRU of claim 11, wherein the configuration information for performing the sensing availability evaluation indicates at least one of:
time period information;
reference signal information;
measurement information; or
reporting information.

20. A method performed by a wireless network in communication with a wireless transmit/receive unit (WTRU), the method comprising:
receiving, at a sensing network function, a request for a sensing service;
selecting a plurality of sensing entities for the sensing service;
transmitting, to the plurality of sensing entities, configuration information for performing a sensing availability evaluation;
receiving, from the plurality of sensing entities, sensing availability information;
selecting one or more sensing entities of the plurality of sensing entities for a sensing operation based on the sensing availability information; and
transmitting, to the one or more sensing entities, sensing configuration information for performing the sensing operation.
